(19) United States
(12) Patent Application Publication
(10) Pub. No.: US 2016/0311059 A1
(43) Pub. Date: Oct. 27, 2016

(54) NOZZLE DEVICE AND MANUFACTURING METHOD OF LAYERED OBJECT

(71) Applicant: KABUSHIKI KAISHA TOSHIBA, Tokyo (JP)

(72) Inventors: Takashi OBARA, Yokohama (JP); Naotada OKADA, Yokohama (JP)

(73) Assignee: KABUSHIKI KAISHA TOSHIBA, Minato-ku, Tokyo (JP)

(21) Appl. No.: 15/102,795

(22) PCT Filed: Sep. 12, 2014
(86) PCT No.: PCT/JP2014/074239

§ 371 Date: Jun. 8, 2016

(30) Foreign Application Priority Data
Mar. 18, 2014 (JP) 2014-054369

(51) Int. Cl. B23K 26/14; B23K 26/144; B23K 26/082; B23K 26/342

(52) U.S. Cl. CPC B23K 26/1462; B23K 26/342; B23K 26/144; B23K 26/082; B33Y 10/00

(57) ABSTRACT

A nozzle device includes a nozzle, an optical system, and a controller. The nozzle can discharge a material and to irradiate energy rays, and moves relatively to an object. The optical system can change an irradiation direction of the energy rays. The controller controls the optical system to change the irradiation direction of the energy rays and to irradiate the energy rays to at least one of a primary side or a secondary side of an advancing direction of the nozzle.

### FIELD

Embodiments of the present invention relate to a nozzle device, a layered object manufacturing device, and a manufacturing method of a layered object.

### BACKGROUND

Conventionally, a technique called a directed energy deposition method has been known as a method of manufacturing a layered object. In the directed energy deposition method, a powdered metallic material is ejected and the material is melted by laser light irradiated thereto to form a layer, and such a process is repeated such that layers are layered to manufacture a layered object having a three-dimensional shape.

As a layered object manufacturing device which manufactures such a layered object, a technique is also known that can form a layer having a certain shape by moving a nozzle, which is capable of ejecting a material and is capable of irradiating laser light, using a moving device.

### CITATION LIST

### Patent Literature

Patent Literature 1: Japanese Laid-open Patent Publication No. 2007-301980

### SUMMARY OF THE INVENTION

### Problem to be Solved by the Invention

A problem to be solved by the invention is to provide a nozzle device, a layered object manufacturing device, and a manufacturing method of a layered object that can melt a material supplied to a position deviated from a supply position of the material.

### BRIEF DESCRIPTION OF DRAWINGS

FIG. 1 is an explanatory view schematically illustrating a configuration of a layered object manufacturing device according to one embodiment.

FIG. 2 is an explanatory view schematically illustrating a configuration of a main part of the layered object manufacturing device.

FIG. 3 is an explanatory view illustrating one example of manufacture of a layered object using the layered object manufacturing device.

FIG. 4 is an explanatory view illustrating one example of manufacture of the layered object using the layered object manufacturing device.

### DETAILED DESCRIPTION

A nozzle device according to an embodiment includes a nozzle, an optical system, and a controller. The nozzle discharges a material and irradiates energy rays. The optical system is provided to be capable of changing an irradiation direction of the energy rays. The controller controls the optical system to change the irradiation direction of the energy rays.

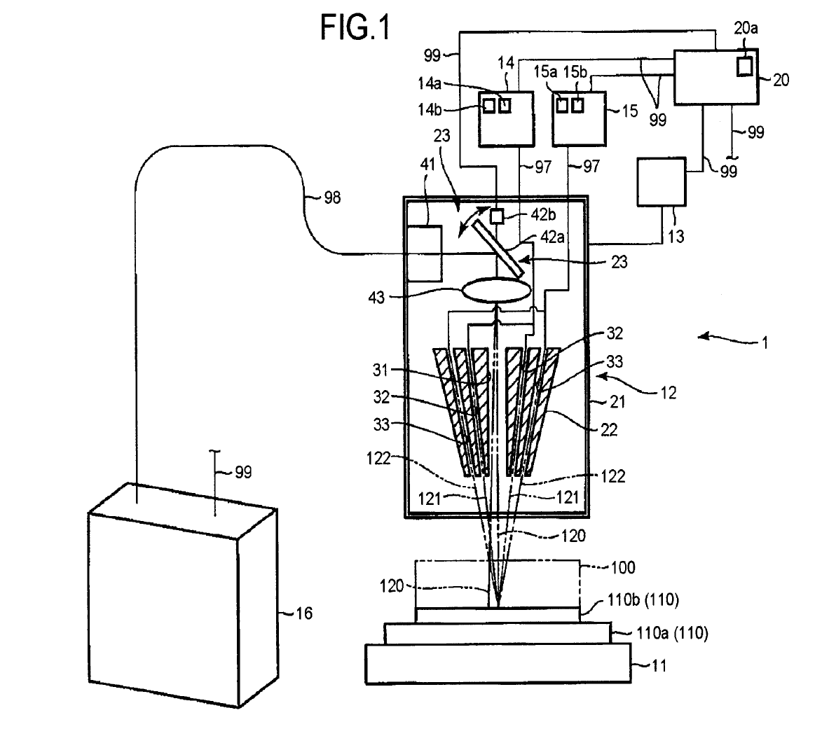

The following describes a layered object manufacturing device 1 and a manufacturing method of a layered object 100 according to a first embodiment with reference to FIGS. 1 to 4.

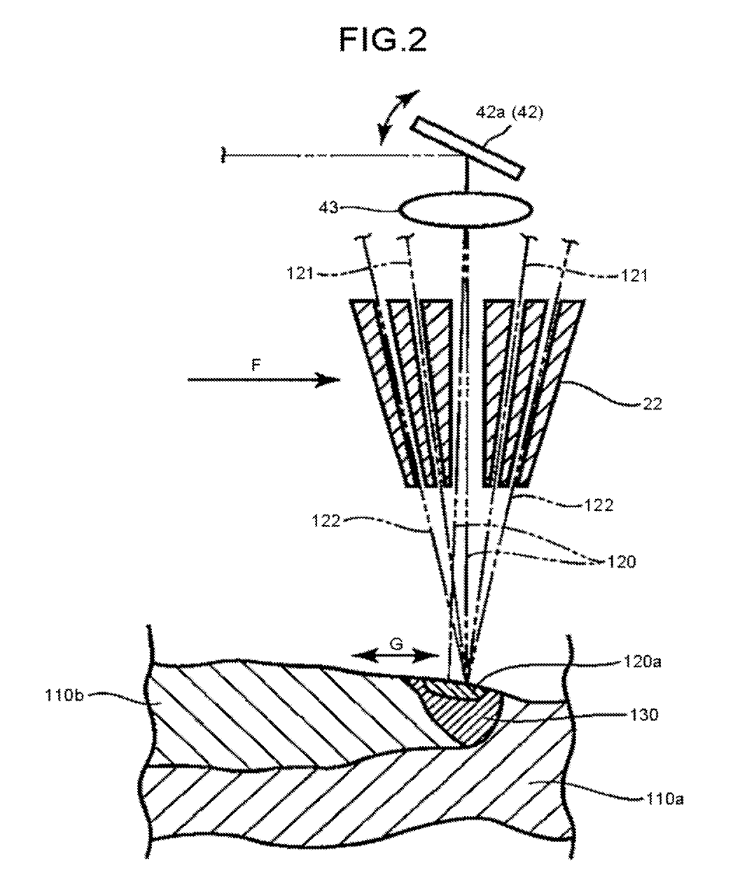

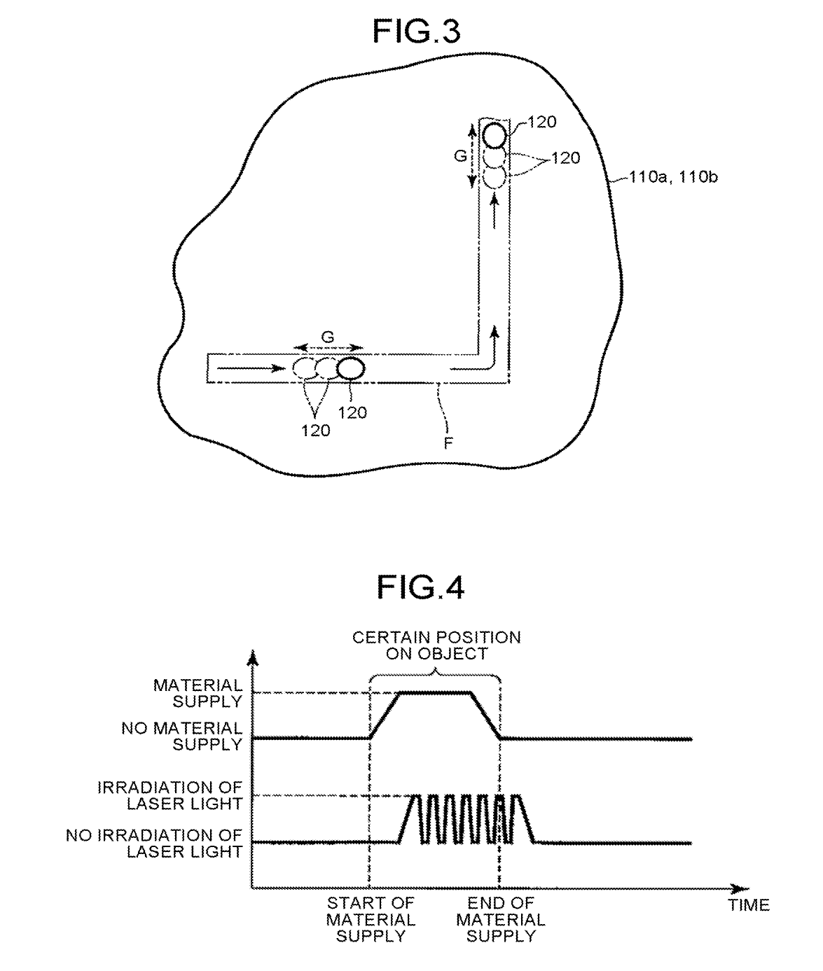

FIG. 1 is an explanatory view schematically illustrating a configuration of the layered object manufacturing device 1 according to one embodiment. FIG. 2 is an explanatory view schematically illustrating a configuration of a nozzle device 12 of the layered object manufacturing device 1. FIG. 3 is an explanatory view illustrating one example of manufacture of the layered object 100 using the layered object manufacturing device 1. FIG. 4 is an explanatory view illustrating one example of manufacture of the layered object 100 using the layered object manufacturing device 1.

As illustrated in FIG. 1, the layered object manufacturing device 1 includes: a stage 11; the nozzle device 12; a moving device 13; a material supply device 14; a gas supply device 15; a light source 16; and a controller 20. The layered object manufacturing device 1 is configured to be capable of manufacturing the layered object 100 having a certain shape by supplying laser light 120 and a material 121 to an object 110 provided on the stage 11 from the nozzle device 12 and the material supply device 14. The stage 11 and nozzle device 12 are arranged in a treatment tank, for example, and the layered object manufacturing device 1 shapes the layered object 100 under an inert gas atmosphere.

The object 110 is a base 110a for shaping the layered object 100 thereon or a layer 110b that is a part of the layered object 100. The object 110 serves as the object to which the material 121 is supplied by the nozzle device 12.

The material 121 is a powdered metallic material. A single metallic material or a plurality of different metallic materials is used as the material 121.

The stage 11 is configured to be capable of supporting the object 110 thereon.

The nozzle device 12 is configured to be capable of selectively supplying the material 121 by a certain amount to the object 110 on the stage 11 and to be capable of emitting the laser light 120 as energy rays melting the material 121. Specifically, the nozzle device 12 includes: an outer housing 21; a nozzle 22 housed in the outer housing 21; and an optical system 23 housed in the outer housing 21.

The outer housing 21 is connected to the moving device 13 and is configured to be capable of moving with respect to the stage 11. The nozzle 22 is connected to the material supply device 14, the as supply device 15, and the optical system 23. The nozzle 22 is connected to each of the material supply device 14 and the gas supply device 15 with a supply pipe 97. The nozzle 22 includes: a light passage 31 that allows passage of the laser light 120 emitted from the optical system 23; a material ejection port 32 that supplies the material 121 to the object 110 from the end thereof; and a gas ejection port 33 that supplies gas 122 to the object 110 from the end thereof.

As illustrated in FIG. 1, the light passage 31 is formed to have an inner diameter that allows passage of the laser light 120 and the irradiation of the laser light 120 to the object 110 from the optical system 23 even when an irradiation direction of the laser light 120 is changed in a certain angle range. In other words, the light passage 31 is a columnar hole having the axial center along the gravity direction and is configured to allow passage of the laser light 120 slanted with respect to the axial center by a certain angle. The certain angle range of the laser light 120 is an angle range that causes the laser light 120 to be irradiated in an irradiation range 120a of the laser light 120 irradiated to the object 110.

The material ejection port 32 is provided in plurality, for example. The plurality of material ejection ports 32 are formed by being slanted with respect to the light passage 31 such that the material 121 supplied from the material supply device 14 is ejected to the object 110 and the ejected material 121 converges in a certain area. The certain area in which the ejected material 121 converges is a position that is on the object 110 and where the layer 110b is formed.

The gas ejection port 33 is provided in plurality, for example. The plurality of as ejection ports 33 are formed by being slanted with respect to the light passage 31 such that the gas supplied from the gas supply device 15 is ejected and the ejected gas 122 converges in a certain area. The gas ejection ports 33 are arranged outside the material ejection ports 32 and around the optical passage 31 serving as the center, and are configured to have the ejected gas 122 converge at the position at which the material 121 ejected from the material ejection ports 32 converges.

The optical system 23 is connected to the light source 16 with a cable, e.g., an optical fiber 98. In the explanation about the optical system 23, a side of the light source 16 in the emitting direction of the laser light 120 emitted from the light source 16 is defined as a primary side, and a side of the object 110, to which the laser light 120 is applied from the optical system 23, is defined as a secondary side. The optical system 23 includes: a lens device 41 provided on the secondary side (emitting side) of the optical fiber 98; a galvano scanner 42 provided on the secondary side (emitting side) of the lens device 41; and an Fe lens 43 provided on the secondary side (emitting side) of the galvano scanner 42.

The lens device 41 is configured to be capable of converting the laser light 120 emitted from the light source 16 via the optical fiber 98 into parallel light and to be capable of emitting the laser light 120 after the conversion to the galvano scanner 42.

The galvano scanner 42 includes: a galvano mirror 42a; and a motor 42b that can rotate the galvano mirror 42a in a certain angle range. The galvano scanner 42 is connected to the controller 20 with a signal line 99. The galvano scanner 42 is configured to enable the motor 42b to slant the galvano mirror 42a in a certain angle range such that the incident laser light 120 is reflected at a certain reflection angle and the reflected laser light 120 is emitted to the Fθ lens 43. The galvano scanner 42 has two axes in an X direction and a Y direction perpendicular to the X direction along the horizontal direction, for example.

The Fθ lens 43 emits the laser light 120 incident at a certain angle range to the light passage 31. The Fθ lens 43 is configured to be capable of adjusting a focal point of the laser light 120. The Fθ lens 43 is configured to be capable of readily ensuring a position accuracy of the focal point in a height direction even when an angle of the incident laser light 120 is changed by the galvano scanner 42. In other words, the Fθ lens 43 is configured to irradiate the laser light 120 to the object 110 while the focal point is adjusted on the object 110 and to be capable of maintaining the focal point position such that the focal point is positioned on the object 110 when the irradiation angle of the laser light 129 is changed by the galvano scanner 42 in the irradiation.

The moving device 13 is connected to the controller 20 with the signal line 99. The moving device 13 moves the nozzle device 12 and the object 100 relative to each other. The moving device 13 is configured to be capable of moving the nozzle device 12 in a feeding direction F to form the layer 110b.

The material supply device 14 is connected to the controller 20 with the signal line 99. The material supply device 14 includes: a tank 14a that stores therein the material 121; and a supply unit 14b that supplies the material 121 to the nozzle 22 from the tank 14a by a certain amount. The material supply device 14 discharges the material 121 via the nozzle 22. The material 121 stored in the tank 14a is a powdered metallic material. The supply unit 14b is configured to be capable of supplying the material 121 in the tank 14a to the nozzle 22 using an inert gas such as nitrogen or argon as a carrier, for example. The supply unit 14b is configured to be capable of adjusting a supply amount of the supplied material 121 and an ejection speed (a supply speed) of the material 121 ejected from the nozzle 22.

The gas supply device 15 is connected to the controller 20 with the signal line 99. The gas supply device 15 includes: a tank 15a that stores therein the gas 122; and a supply unit 15b that supplies the gas 122 to the nozzle 22 from the tank 15a by a certain amount. The gas 122 stored in the tank 15a is an inert gas such as nitrogen or argon. The gas 122 supplied by the gas supply device 15 is configured to be capable of preventing oxidization of the layer 110b or formation of a compound as a result of reaction with the gas when the layer 110b is formed by melting the material 121 ejected on the object 120 from the nozzle 22.

The supply unit 15b is configured to be capable of supplying the gas 122 to the nozzle 22. The supply unit 15b is configured to be capable of adjusting a supply amount of the supplied gas 122 and an ejection speed (a supply speed) of the gas 122 ejected from the nozzle 22.

The light source 16 is a supply source of the laser light 120. The light source 16 has an oscillation element and is configured to be capable of emitting the laser light 120 having power density capable of melting the material 121 to the optical fiber 98. The light source 16 is configured to be capable of changing the power density of the laser light 120 to be emitted.

The controller 20 is electrically connected, with the signal line 99, to the moving device 13, the material supply device 14, the gas supply device 15, the light source 16, and the motor 42b.

The controller 20 is configured to be capable of moving the nozzle 22 in three axis directions of the X direction, the Y direction, and a Z direction perpendicular to the X direction and the Y direction by controlling the moving device 13. The controller 20 is configured to be capable of supplying the material 121, and adjusting a supply amount and a supply speed of the material 121 by controlling the material supply device 14.

The controller 20 is configured to be capable of supplying the gas 122, and adjusting a supply amount and a supply speed of the gas 122 by controlling the gas supply device 15. The controller 20 is configured to be capable of adjusting the power density of the laser light 120 emitted from the light source 16 by controlling the light source 16.

The controller 20 is configured to be capable of adjusting a tilting angle of the galvano mirror 42a so as to adjust the emitting angle of the laser light 120 emitted from the nozzle 22 (the galvano scanner 42) by controlling the motor 42b of the galvano scanner 42.

The controller 20 includes a storage 20a. The storage 20a stores therein a shape of the layered object 100 to be manufactured as a threshold.

The controller 20 has the following functions (1) and (2).

The function (1) is a function of discharging the material 121 from the nozzle 22.

The function (2) is a function of applying the laser light 120 in a certain range from the nozzle 22.

The following describes the functions (1) and (2).

The function (1) is a function that adjusts the supply amount and the supply speed of the material 121 from the nozzle 22 to discharge (eject) it and that moves the nozzle 22 in accordance with the shape of the layer 110b to be formed, based on the material 121 to form each layer 110b of the layered object 100 stored in the storage 20a.

Specifically, when a certain layer 110b of the layered object 100 is formed, the moving device 13 is controlled such that the moving device 13 moves the nozzle device 12 in the certain feeding direction F with respect to the object 110 along the feeding direction F illustrated in FIGS. 2 and 3. The material supply device 14 is controlled, in line with the movement of the nozzle device 12, such that the material 121 used for forming the layer 110b is ejected to the object 110 from the nozzle 22 at a certain supply amount and a certain supply speed. Simultaneously, the gas supply device 15 is controlled such that the gas 122 serving as a purge gas is ejected to the object 110 from the nozzle 22 at a certain supply amount and a certain supply speed. In this way, the function (1) is the function that moves the nozzle 22 in a certain trajectory and supplies the material 121 and the gas 122 to the object 110.

The function (2) is a function that causes the laser light 120 to be irradiated in a certain range of the object 110 to melt the material 121 to form a molten pool 130 when the function (1) supplies the material 121 to the object 110. The molten pool 130 is a molten portion configured by the material 121 and the object 100 melted by the irradiation of the laser light 120.

Specifically, when the moving device 13 moves the nozzle device 12 in the certain feeding direction F while the material 121 is ejected, the galvano scanner 42 is controlled such that the laser light 120 is irradiated to the supply position of the material 121 and the gas 122 to form the molten pool 130 at the supply position. The galvano scanner 42 is controlled to continuously rotate the galvano mirror 42a in a certain angle range, so that the irradiation direction of the laser light 120 is changed to continuously irradiate the laser light 120 in the certain application range 120a, and thus irradiating the laser light 120 to the supply position and the primary side of the supply position in the feeding direction F.

In other words, the irradiation is alternately performed on the supply position of the material 121 and a part of the trajectory along which the nozzle 22 has passed. Furthermore, in the other words, the angle adjustment is repeatedly performed on the galvano scanner 42 at a certain frequency continuously in a certain angle range so as to swing the laser light 120 in a sweep direction G of the laser light 120 at a certain frequency, resulting in the laser light 120 being irradiated to the supply position of the material 121 and the primary side of the supply position in the feeding direction F. As a result, the molten pool 130 is formed in the irradiation range 120a of the laser light 120.

The feeding direction F of the nozzle 22 (the nozzle device 12) is an advancing direction (moving direction) of the nozzle 22 to form the layer 110b having a certain shape. The sweep direction G is a swing direction of the laser light 120 along the feeding direction F as a result of the rotation of the galvano mirror 42a.

The following describes the function (2) more specifically with reference to FIGS. 2 to 4 in relation to the irradiation of the laser light 120 at a certain position on the object 110. First, the nozzle 22 is moved along the feeding direction F and, at a certain position, the material supply starts as illustrated on the upper side in FIG. 4. With the movement of the nozzle 22, the supply amount of the material 121 is gradually increased up to a certain amount.

Next, the nozzle 22 is moved so as to move the supply position of the material 121 and the angle adjustment on the galvano scanner 42 in a certain angle range is repeatedly performed. As a result, the laser light 120 is repeatedly irradiated to the material supply position and the primary side thereof. When the nozzle 22 is caused to be further moved, a part of the material 121 to be supplied to the material supply position may be scattered and supplied on the primary side some times. In such case, because the laser light 120 is also irradiated to the primary side of the material supply position, the laser light 120 is irradiated to the primary side in the advancing direction of the nozzle 22 and the material 121 is melted even when the material 121 is scattered on the primary side in the advancing direction of the nozzle 22 where the nozzle 121 has passed.

In this way, the function (2) continuously swings the laser light 120 in the certain irradiation range 120a in the sweep direction G, so that the laser light 120 is irradiated to the supply position of the material 121 and the primary side of the supply position, and the material 121 is melted. Therefore, the function (2) described as above is the function that forms the layers 110b configuring the layered object 100 with the supplied material 121.

The following describes a manufacturing method of the layered object 100 using the layered object manufacturing device 1 with reference to FIGS. 3 and 4.

The controller 20 controls the material supply device 14 and the gas supply device 15 such that the material 121 and the gas 122 are supplied onto the object 110 on which the layered object 100 is manufactured from the nozzle 22 at the certain supply amounts and certain supply speeds. The controller 20 controls the light source 16 and the optical system 23 such that the laser light 120 is irradiated to the supplied material 121 to melt the material 121.

The controller 20 controls the moving device 13 such that the nozzle device 12 moves along the feeding direction F set according to the shape of the layer 110b to be formed. After the start of the movement of the nozzle device 12, the controller 20 controls the galvano scanner 42 such that the tilting angle of the galvano mirror 42a is adjusted in a certain angle range to swing the laser light 120 in the sweep direction G at a certain frequency, resulting in the laser light 120 being irradiated in the certain irradiation range 120a. With the movement of the nozzle device 12 in this state, the laser light 120 is irradiated to the supply position of the material 121 under the nozzle 22 and the primary side of the supply position. As a result, as illustrated in FIG. 2, the molten pool 130 is formed, and the material 121 supplied from the nozzle 22 and the material 121 scattered on the primary side of the supply position of the material 121 in the feeding direction F are melted by the laser light 120.

The controller 20 further causes the nozzle device 12 to move continuously along the feeding direction F to supply the material 121 and the gas 122. The controller 20 irradiates the laser light 121 to the object 110 with the supplied material 121 along the sweep direction G, and forms the certain layer 110b. The controller 20 causes the layer 110b to be repeatedly formed and layered until the shape of the layered object 100 stored in the storage 20a is achieved, so that the layered object 100 is manufactured.

The layered object manufacturing device 1 thus configured, controls the optical system 23 so as to swing the laser light 120 in the sweep direction G, thereby enabling the laser light 120 to be irradiated to the supplied material 121 and the primary side of the supply position of the material 121 in the feeding direction F of the nozzle device 12.

The molten pool 130 is, thus, formed while the laser light 120 is irradiated to the object 110 even after the passage of the nozzle device 12. As a result, the material 121 scattered and supplied on the primary side of the supply position of the material 121 in the feeding direction F of the nozzle device 12 can be melted while the material 121 is being supplied. The material 121 supplied on the primary side deviated from the certain supply position of the material 121, thus, can be melted.

Thus, it is possible to prevent the adherence of unmolten material 121 to the softened layer 110b and the presence of unmolten material 121 remaining on the layer 110b after solidification, thereby it is possible to certainly melt the supplied material 121. As a result, surface roughness of the formed layer 110b and layered object 100 can be improved.

Specifically, the molten pool 130, which is formed on the object 110 as the result of the irradiation of the laser light 120, is naturally cooled and gradually solidifies to form the layer 110b when the irradiation of the laser light 120 to the molten pool 130 ends. Because the layer 110b solidifies through a softened state, when the material 121 is scattered on the layer 110b in the softened state, the material 121 adheres to the softened layer 110b and the unmolten material 121 is fixed to the layer 110b. Because the unmolten material 121 is provided on the surface of the formed layer 110b or the formed layered object 100, the surface roughness thereof may be increased.

However, the layered object manufacturing device 1 can melt the material 121 scattered on the layer 110b where the nozzle 22 has passed by irradiating the laser light 120 to the trajectory along which the nozzle 22 has passed with, that is, by irradiating the laser light 120 to the primary side of the supply position of the material 121 in the feeding direction F of the nozzle device 12. Thus, it is possible to prevent the adherence of unmolten material 121 to the layer 110b, which solidifies after the adherence. As a result, it is possible to enable the shaped layered object 1 to have good surface roughness.

The layered object manufacturing device 1 is configured to widen the actual irradiation range 120a of the laser light 120 by swinging the laser light 120 in the sweep direction G along the feeding direction F of the nozzle 22 without increasing the focal point area of the laser light 120 irradiated to the object 110. Therefore, the focal shape of the laser light 120 is not required to be increased, thereby fine shaping can be achieved.

The manufacturing method of the layered object 100 using the layered object manufacturing device 1 according to the embodiment thus described, can certainly melt the material 121, even when the material 121 is supplied to the melted or softened layer 110b at the position deviated from the supply position in the supply of the material 121, by irradiating the laser light 120 to the object 110 by swinging the laser light 120 by a certain width from the supply position of the material 121.

The manufacturing method of the layered object 100 using the layered object manufacturing device 1 according to the embodiment is not limited to the above described configuration. In the exemplary configuration described above, the controller 20 controls the galvano scanner 42 such that the laser light 120 is irradiated to the supply position of the material 121 supplied from the nozzle 22 and the primary side of the supply position in the feeding direction F of the nozzle device 12; however, the embodiment is not limited to this example. As another embodiment, the controller 20 may be configured to be capable of controlling the galvano scanner 42 such that the laser light 120 is swung to the primary side and the secondary side of the supply position of the material 121 in the feeding direction F of the nozzle device 12. The layered object manufacturing device 1 thus configured can form the molten pool 130 at the supply position of the material 121 and on the primary side of the supply position and melt the material 121 supplied to the supply position and the material 121 scattered on the primary side of the supply position, because the laser light 120 is irradiated to the primary side and the secondary side of the supply position of the material 121 along the feeding direction F. In addition, the object 110 on the secondary side of the nozzle 22 in the feeding direction F can be preliminarily heated by the laser light 120, thereby the molten pool 130 can be formed in a short time when the nozzle 22 is further moved.

In the exemplary configuration described above, the object 110 and the material 121 are melted by the irradiation of the laser light 120; however, the configuration is not limited to the example. Other energy rays may be used instead of the laser light 120 as long as the energy rays can melt the object 110 and the material 121, and the melting range can be swung in the sweep direction G.

While the embodiments of the present invention have been described, the embodiments have been presented by way of examples only, and are not intended to limit the scope of the invention. The novel embodiments described herein may be embodied in a variety of other forms. Furthermore, various omissions, substitutions, and changes of the embodiments described herein may be made without departing from the spirit of the invention. The accompanying claims and their equivalents are intended to cover the embodiments or the modifications as would fall within the scope and spirit of the invention.

1. A nozzle device comprising:
a nozzle to discharge a material and to irradiate energy rays, the nozzle moving relatively to an object;
an optical system that is provided to be capable of changing an irradiation direction of the energy rays; and
a controller that controls the optical system to change the irradiation direction of the energy rays and to irradiate the energy rays to at least one of a primary side or a secondary side of an advancing direction of the nozzle.

2. The nozzle device according to claim 1, wherein the controller controls a moving direction of the nozzle that supplies the material.

3. The nozzle device according to claim 1, wherein the controller continuously changes the irradiation direction of the energy rays.

4-6. (canceled)

7. A manufacturing method of a layered object, the method comprising:
supplying a material to a material supply position on an object from a nozzle; and
changing, by an optical system, an irradiation position of energy rays between the material supply position and a part of a layered object manufactured by the already supplied material, and irradiating the energy rays to at least one of a primary side or a secondary side of an advancing direction of the nozzle.

8. The manufacturing method of a layered object according to claim 7, further comprising controlling a moving direction of the nozzle that supplies the material.

9-10. (canceled)

11. The manufacturing method of a layered object according to claim 7, further comprising continuously changing an irradiation direction of the energy rays.
